(19) United States
(12) Patent Application Publication
(10) Pub. No.: US 2019/0113885 A1
(43) Pub. Date: Apr. 18, 2019

(54) INCOHERENT HOLOGRAPHIC IMAGING WITH METASURFACES

(71) Applicant: California Institute of Technology, Pasadena, CA (US)

(72) Inventors: Amir ARBABI, PASADENA, CA (US); Leon C. DING, PASADENA, CA (US); Ehsan ARBABI, PASADENA, CA (US); Andrei FARAON, PASADENA, CA (US)

(21) Appl. No.: 16/160,849

(22) Filed: Oct. 15, 2018

Related U.S. Application Data
(60) Provisional application No. 62/572,736, filed on Oct. 16, 2017.

(51) Int. Cl. G03H 1/06; G02B 5/30; H04N 5/225; G03H 1/04

(52) U.S. Cl. CPC G03H 1/06; G02B 5/3025; G03H 1/041; H04N 5/2254; G02B 5/3083

(57) ABSTRACT

A birefringent metasurface lens formed by an array of nanoposts generates different phase profiles for different incident electromagnetic waves of different polarization. A first polarization is focused at a first focal length, while a second polarization is focused at a second focal length. A variable phase retarder and a polarizer generate interference patterns for each phase difference between the two incident polarizations. The interference patterns are used to generate a hologram, allowing reconstruction of the image of an object.

### CROSS REFERENCE TO RELATED APPLICATIONS

The present application claims priority to U.S. Provisional Patent Application No. 62/572,736, filed on Oct. 16, 2017, the disclosure of which is incorporated herein by reference in its entirety.

### STATEMENT OF INTEREST

This invention was made with government support under grant 1512266 awarded by the National Science Foundation. The government has certain rights in the invention.

### TECHNICAL FIELD

The present disclosure relates to imaging. More particularly, it relates to incoherent holographic imaging with metasurfaces.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates an exemplary array of nanoposts.

FIG. 2 illustrates metasurfaces with two focal lengths for two orthogonal polarizations.

FIG. 3 illustrates interference patterns controlled by a wave plate.

FIG. 4 illustrates off-axis operation of metasurfaces with two focal lengths for two orthogonal polarizations.

FIG. 5 illustrates the off-axis reconstructed point spread function for the metasurface with two focal lengths, versus the off-axis point spread function of a regular metasurface lens

FIG. 6 illustrates patterns of a dot grid and reconstructed point spread functions at the dot grid locations.

FIG. 7 illustrates intensity plots of the off-axis point spread function for different bandwidths.

FIG. 8 illustrates imaging of a black and white checkerboard pattern.

FIG. 9 illustrates a scanning electron micrograph of a fabricated metasurface birefringent lens viewed from above.

FIG. 10 illustrates a scanning electron micrograph of a fabricated metasurface birefringent lens viewed from a tilted angle.

FIG. 11 illustrates three measured interference patterns of a point source.

FIG. 12 illustrates the reconstructed focus pattern for FIG. 11.

FIG. 13 illustrates the experimentally captured interference patterns and the reconstructed images using the holographic method of the present disclosure.

FIGS. 14-15 illustrate schematics of the holographic imaging method of the present disclosure, for microscopy.

### SUMMARY

In a first aspect of the disclosure, a device is described, the device comprising: a birefringent metasurface lens, comprising an array of nanoposts configured to focus incident electromagnetic waves of a first polarization to a first focal length, and incident electromagnetic waves of a second polarization to a second focal length; a variable phase retarder between the birefringent metasurface lens and a camera, the variable phase retarder configured to vary a phase difference between the electromagnetic waves of the first polarization and the electromagnetic waves of the second polarization; and a polarizer between the variable phase retarder and the camera.

In a second aspect of the disclosure, a method is described, the method comprising: providing a birefringent metasurface lens comprising an array of nanoposts; providing a variable phase retarder between the birefringent metasurface lens and a camera; providing a polarizer between the variable phase retarder and the camera; focusing electromagnetic waves of a first polarization, from an object to be imaged and incident on the birefringent metasurface lens, to a first focal length, and electromagnetic waves of a second polarization, from the object and incident on the birefringent metasurface lens, to a second focal length; varying, by the variable phase retarder, a phase difference between the electromagnetic waves of the first polarization and the electromagnetic waves of the second polarization; capturing, by the camera, a plurality of interference patterns for a plurality of phase differences between the electromagnetic waves of the first polarization and the electromagnetic waves of the second polarization, wherein each interference pattern of the plurality of interference patterns corresponds to a phase difference of the plurality of phase differences; and generating a hologram from the plurality of interference patterns.

In a third aspect of the disclosure, a device is described, the device comprising: a birefringent metasurface, comprising an array of nanoposts configured to scatter incident electromagnetic waves of a first polarization with a first phase profile, and incident electromagnetic waves of a second polarization with a second phase profile; a variable phase retarder between the birefringent metasurface and a camera, the variable phase retarder configured to vary a phase difference between the electromagnetic waves of the first polarization and the electromagnetic waves of the second polarization; and a polarizer between the variable phase retarder and the camera.

### DETAILED DESCRIPTION

The present disclosure describes incoherent holographic imaging using a single birefringent metasurface lens. The imaging technique described in the present disclosure overcomes the monochromatic and chromatic aberration challenges of imaging with diffractive lenses, and results in high quality imaging with a wide field of view and wide bandwidth. The technique is based on forming interference patterns of each point of an object, using a birefringent lens with two different focal distances for two different polarizations of light (linear, circular, or elliptical). Using a variable wave plate, it is possible to form a complex hologram containing the phase and amplitude data of the object. In addition to correcting the imaging aberrations, this method can be used for post-capture refocusing of the image, through changing the reconstruction distance in the algorithm used for recovering the image from the hologram.

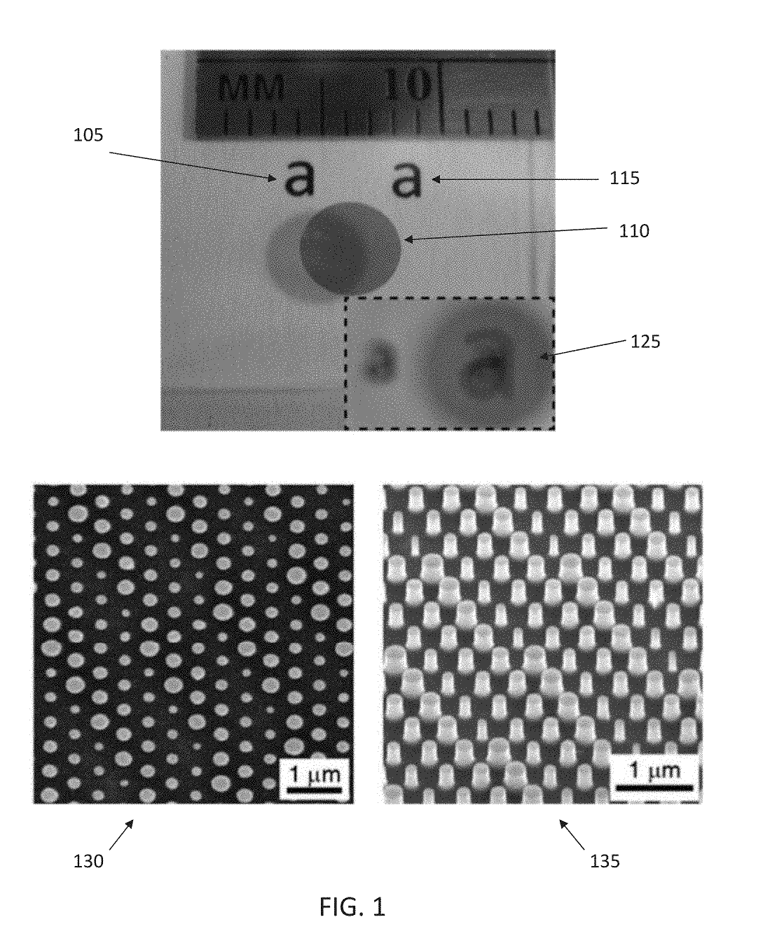

A basic way to image an object is by using the focus of a single lens, for example a magnifying glass. The drawback of this basic technique is that magnifying lenses have higher distortion the further away the image is from the center of the lens. This undesirable effect is remedied by using a cascade of several glass lenses, for example in a camera zoom setup. Due to the considerable bulk from a cascade of glass lenses, a question of interest is whether or not imaging can be achieved using a smaller system. Metasurface phase masks are a potential solution to this problem. These devices, typically no larger than a coin, consist of millions to billions of high refractive index nanoposts. By arranging the nanoposts in a particular manner, it is possible to produce high efficiency lenses with large numerical apertures and a much more precise focal length compared to a glass lens. FIG. 1 illustrates an image of a metasurface lens (110), showing imaging distortions. Two copies of the letter “a” printed on a piece of paper (105, 115) are illustrated, along with the image (125) formed by the metasurface lens for (115). As seen here, (125) shows a high quality sharp image towards the center, where even the paper texture is visible. The image is blurry and has a lower contrast towards the periphery. This demonstrates the imaging limitations of a single metasurface lens, caused by monochromatic aberrations. FIG. 1 also illustrates two zoomed-in views (130,135) of the lens (110), showing the array of nanoposts, with the corresponding scale bars of 1 micrometer. The nanoposts act as scattering elements for the electromagnetic waves. By arranging the nanoposts in specific ways, it is possible to control the electromagnetic waves that are either transmitted or reflected by the metasurface. For example, it is possible to control the focal length of the metasurface by selecting the dimensions and arrangement of the nanoposts.

As known to the person of ordinary skill in the art, metasurface lenses, due to their diffractive nature, can suffer from off-axis distortions and chromatic aberrations. The present disclosure solves these issues based on holography, a method for three dimensional (3D) imaging. In holography, an interference pattern, formed by a reference beam and an object beam, is recorded on an electronic light sensor, for example a charge coupled device (CCD). These two waves are usually required to travel the same distance and originate from the same source, in order to obtain proper interference. The 3D image can then be ‘reconstructed’ by illuminating the interference pattern with the reference beam. This process can also be performed digitally using a computer, which is the method used in the present disclosure.

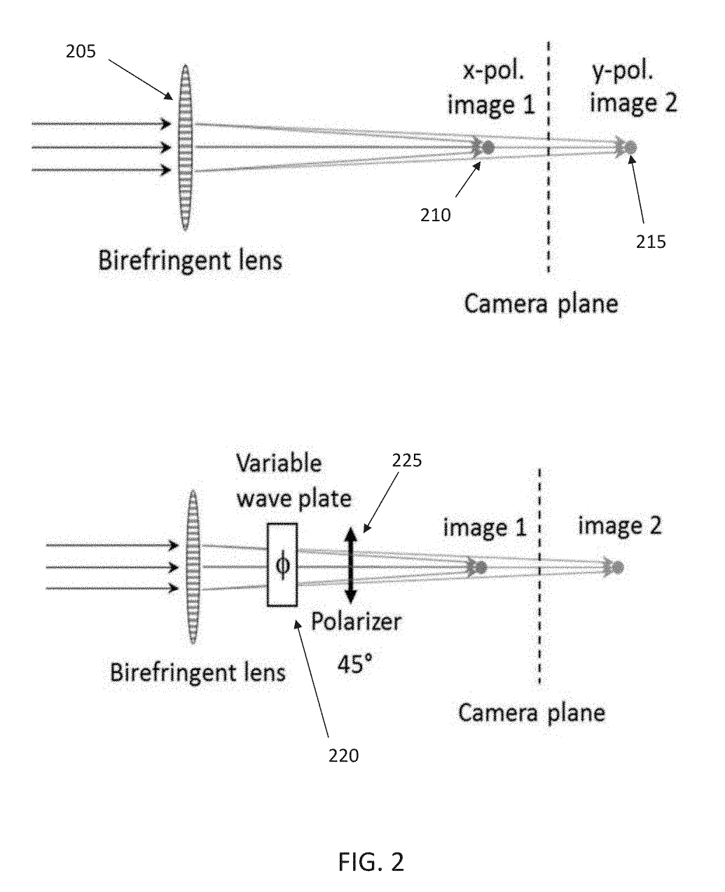

The exemplary holographic system used in the present disclosure is based on Fresnel incoherent correlation holography (FINCH), a holographic technique which is known to the person of ordinary skill in the art, and is described, for example, in Refs. [6,7]. The main difference, compared to the FINCH technique, is that the system used in the present disclosure has only one birefringent metasurface lens (205), as shown for example in FIG. 2. FIG. 2 illustrates an exemplary image formation by a birefringent lens (205) with focal lengths f₁ (210) and f₂ (215) for x and y polarized light, respectively. Therefore, the metasurface lens (205) of FIG. 2 has a first focal length for one polarization and a second focal length for a second polarization. The electromagnetic waves at either polarization will be focused at their respective, different focal lengths. FIG. 2 also illustrates another embodiment of a holographic imaging system, similar to the first embodiment of FIG. 2 described above. This second embodiment adds a variable phase retarder (220) which adds a phase delay to the x polarized light, and a polarizer (225). For example, the polarizer of FIG. 2 has a polarization angled equally distant from the x and y polarizations (45°). This setup effectively combines the two incident, x and y polarizations to form an interference pattern captured by the CCD. The two images are formed on the two sides of the image sensor. For example, image (210) is formed in front of the camera plane, while image (215) is formed behind the camera plane. Therefore, both images (210,215) are not in focus at the image sensor plane.

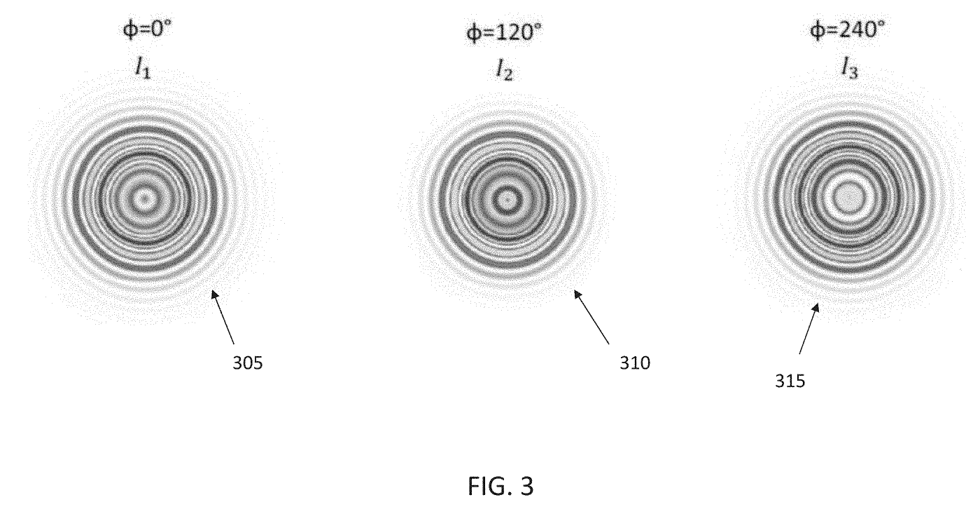

FIG. 3 illustrates simulated interference patterns for three different phases of the variable wave plate (220) of FIG. 2. The resulting intensities are denoted by I₁, I₂, and I₃ for the three phases of 0° (305), 120° (310), and 240° (315), respectively.

As illustrated in FIG. 2, the two interfering beams are generated by the birefringent metasurface lens, which has two different focal distances for the two polarizations. Using a variable wave-plate (e.g. a liquid crystal wave-plate) the phase difference between the x and y polarized lights can be changed. For each phase difference between the two polarized beams, a different interference pattern can be captured with the camera. For instance, three interference patterns can be recorded using a camera, for phase differences of 0°, 120°, and 240°. A linear combination of these patterns is then used to create a complex hologram. After obtaining the hologram, a variety of methods can be used to reconstruct the original image. In some embodiments, a linear filtering method can be used for the reconstruction. This method is described in the following, demonstrating its effectiveness through both simulations and experiments.

In some embodiments, a metasurface lens has a diameter of 800 μm, and focal lengths of f₁=1.25 mm and f₂=1.75 mm for the two orthogonal linear polarizations. The distance between the lens and the CCD is set to 1.5 mm, necessary in this example to have a zero chromatic dispersion, based on the values of the two focal distances. The center wavelength of the incident light is λ₀=850 nm. The choice of these parameters is for this specific design, and can be readily generalized to other wavelengths, ranging from radio frequencies to visible and ultraviolet electromagnetic waves (UV), other lens sizes, and other focal distances for the two polarizations. The setup for this example is illustrated in FIG. 2.

With a point source at r₀=(x₀,y₀,−z₀) in front of a birefringent lens, with focal lengths f₁ and f₂ for x and y polarized light, there will be two resultant fields at the CCD plane. The two fields correspond to the two polarizations, and can be termed u₁ and u₂. By placing a variable wave plate to delay y-polarized light by a phase ϕₙ, and a polarizer at 45° between the lens and the CCD, it is possible to combine the two waves, resulting in an interference intensity pattern on the CCD. The interference pattern can be described as:

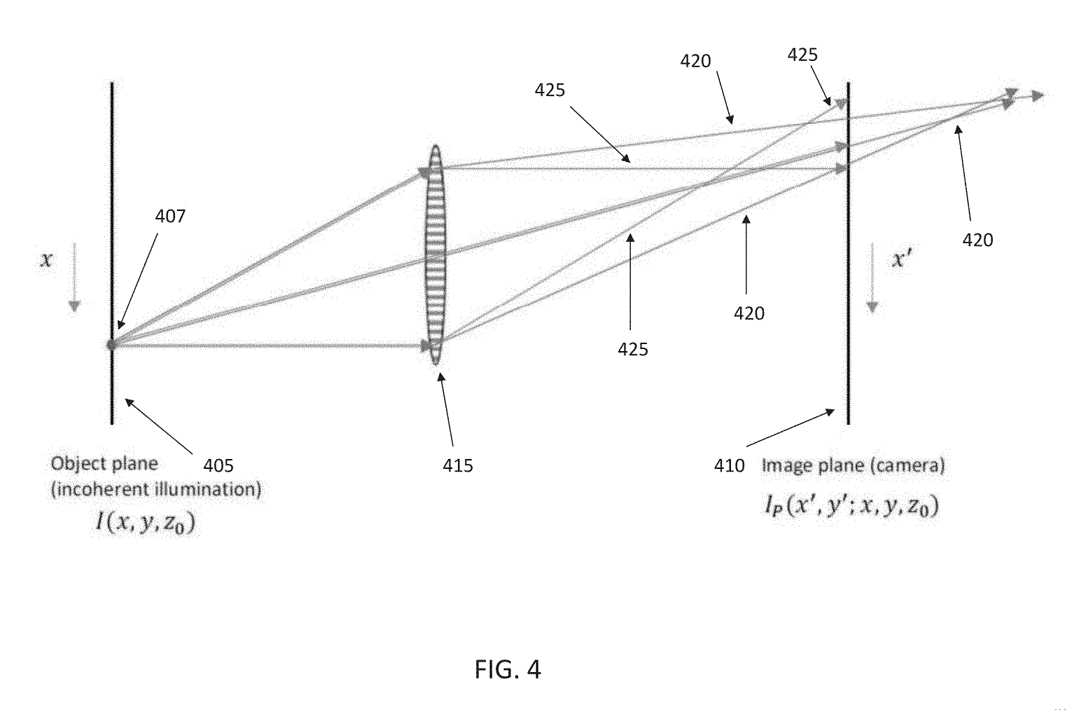

Iₙ(x′,y′)=|u₁(x′,y′)+e^{iϕ}^{ₙ}u₂(x′,y′)|²=|u₁|²+|u₂|²+u₁u*₂e^{-iϕ}^{ₙ}+u₁u₂e^{iϕ}^{ₙ}

where x′ and y′ denote the coordinates on the CCD plane, as shown in FIG. 4. FIG. 4 illustrates a point source (407) in the object plane (405) with incoherent illumination, the image plane (410), the metasurface lens comprising an array of nanoscatterers (415), rays of a first polarization (420) focused at a first focal length behind the image plane, and rays of a second polarization (425) focused at a second focal length in front of the image plane. The illumination should be spatially incoherent so that light from any point in the object plane (405) only interferes with itself at the image plane (410). Otherwise, light emitted from different points in the object plane (405) will interfere on the image plane, introducing an error in the reconstruction process.

As the phase delay of the wave plate is changed, the interference pattern corresponding to each phase delay can be captured. For instance, it is possible to set

$${φ}_{n} = \frac{2 π}{3} ( n - 1 )$$

for n=1,2,3. Three typical simulated interference patterns are shown in FIG. 3, using the above mentioned phases, and assuming a point source. Using the three interference patterns, it is possible to eliminate the background (|u₁|²+|u₂|²) and virtual image (u*₁u₂) terms, and compute the term proportional to the complex hologram u₁u*₂, through the following linear combination:

I_{H}(x′,y′)=I₁(e^{iϕ}^{₃}−e^{iϕ}^{₂})+I₂(e^{iϕ}^{₁}−e^{iϕ}^{₃})+I₃(e^{iϕ}^{₂}−e^{iϕ}^{₁})

A variety of methods can be applied for reconstructing the actual image from I_{H}(x′,y′). The first method introduced here is based on calculating the correlation of I_{H} with the complex, point spread function resulting from a point source at r=(x,y,−z₀), which is defined as I_{P}(x′,y′;x,y,z₀). In this manner, the estimated object intensity Î(x,y,z₀) can be calculated through the following correlation integral:

Î(x,y,z₀)=∫I_{H}(x′,y′)I*_{P}(x′,y′;x,y,z₀)dx′dy′

To reduce the computational costs of the reconstruction algorithm, it can be assumed that the system is approximately shift invariant over small patches around a point r₀=(x₀,y₀,−z₀), and thus it is possible to write:

I_{P}(x′,y′;x,y,z₀)≈I_{P}(x′−x,y′−y;x,y,z₀), (x,y) close to (x₀,y₀)

The specific definition for “close to” can be used as a parameter determining the degree of approximation. The larger the patch, the less number of point spread function calculations is required for the reconstruction. Using this approximation, the estimated intensity in the patch can be written as:

Î(x,y,z₀)=∫I_{H}(x′,y′)I*_{P}(x′−x,y′−y;z₀)dx′dy′

This correlation calculation can also be carried out in the spectral domain (kₓ,k_{y}) using the Fourier transform of I*_{P}. The second method described herein applies a Wiener filter for the reconstruction. Assuming that the point spread function is shift invariant in a small patch, a spectral domain filter can be calculated, for that patch, by Fourier transforming I_{P}(x=x′−x₀,y=y′−y₀;z₀), which is referred to as H_{P}(kₓ,k_{y};x₀,y₀,z₀). It can be noted that the transfer function is also a function of (x₀,y₀), the “center” coordinate of the patch. It is possible to find the corresponding Wiener function through H_{W}=H*_{P}/(|H_{P}|²+N), where N is an estimated noise power. In each patch, the reconstructed image can then be formed through Î(x,y,z₀)=F⁻¹{H_{W}·i_{H}}, where i_{H}(kₓ,k_{y})=F{I_{H}(x′,y′)}, and F{·} denotes the Fourier transformation operator. As demonstrated in the following, if the image plane is divided into a large enough number of patches, the reconstructed image will have good quality throughout the image.

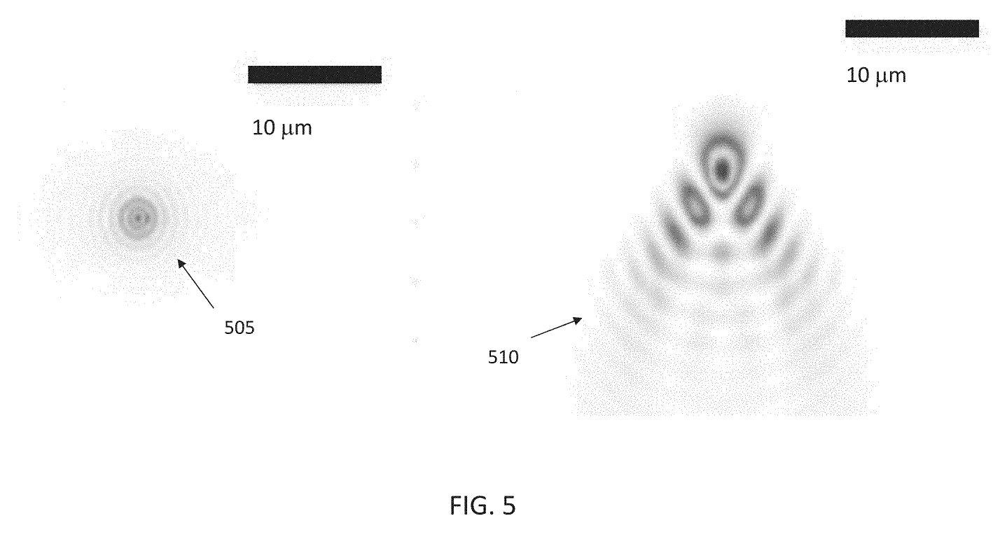

The methods of the present disclosure can correct monochromatic and chromatic aberrations of diffractive imaging systems. FIG. 5 illustrates the simulated reconstructed image (505) of a monochromatic point source placed 10° off-axis of the optical system. The reconstructed image (505) shows minimal aberrations. The image formation and reconstruction are performed via the methods explained above in the present disclosure. For comparison, FIG. 5 also illustrates the image (510) of the same point source, but formed through a regular single diffractive lens. The regular diffractive image (510) shows a high level of aberrations in comparison to the image (505) generated through the holographic imaging method. Two scale bars of 10 micrometers are illustrated in FIG. 5.

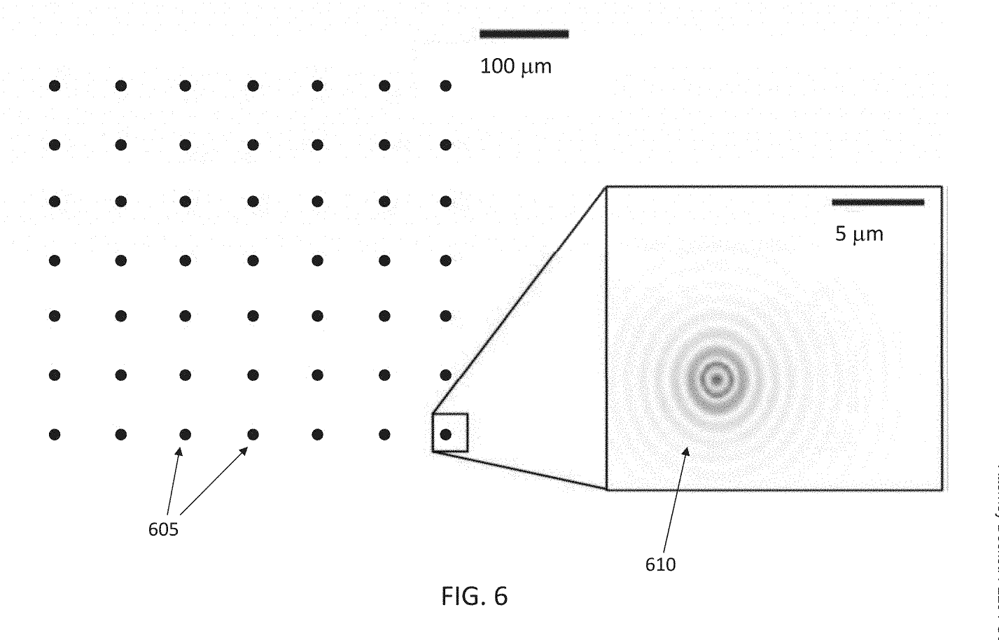

As a second example, FIG. 6 shows the simulated imaging of a 7×7 grid of point sources using the holographic system of the present disclosure. For clarity, the interference patterns are illustrated in FIG. 6 as solid points (605), and their dimensions increased, compared to the scale bar of 100 micrometer. The actual shape structure of each point (605) is illustrated as the interference pattern (610), with its own scale bar of 5 micrometer. The interference pattern (610) shows the correction of monochromatic aberrations through the methods described in the present disclosure. FIG. 6 illustrates the successful reconstruction of a 7×7 grid of points using the single lens holographic technique of the present disclosure, without aberrations or distortions.

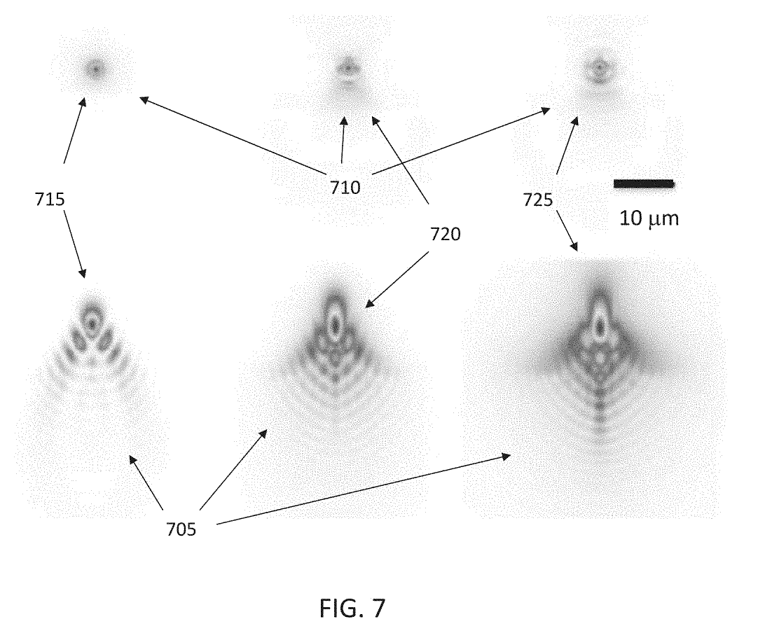

FIG. 7 illustrates intensity plots for different bandwidths, comparing conventional diffractive lens imaging to the single lens holographic imaging method of the present disclosure. The results of conventional imaging are illustrated as (705), while those obtained with the single lens holographic imaging are illustrated as (710), with a 10 micrometer scale bar. All six points (705,710) were imaged at an angle of 10° from the optical axis. The bandwidth Δλ is calculated here using a full-width-at-half-maximum definition: for points (715) the relative bandwidth Δλ/λ₀=1.2%; for points (720) Δλ/λ₀=4.7%; for points (725) Δλ/λ₀=11.8%.

FIG. 7 demonstrates the capability of the system of the present disclosure in correcting chromatic aberrations. All six points in FIG. 7 are imaged at a 10° angle. The images formed by the holographic imaging system (710) show a clear reduction of aberrations, and a resolution increase in comparison to the images formed by a single diffractive lens (705).

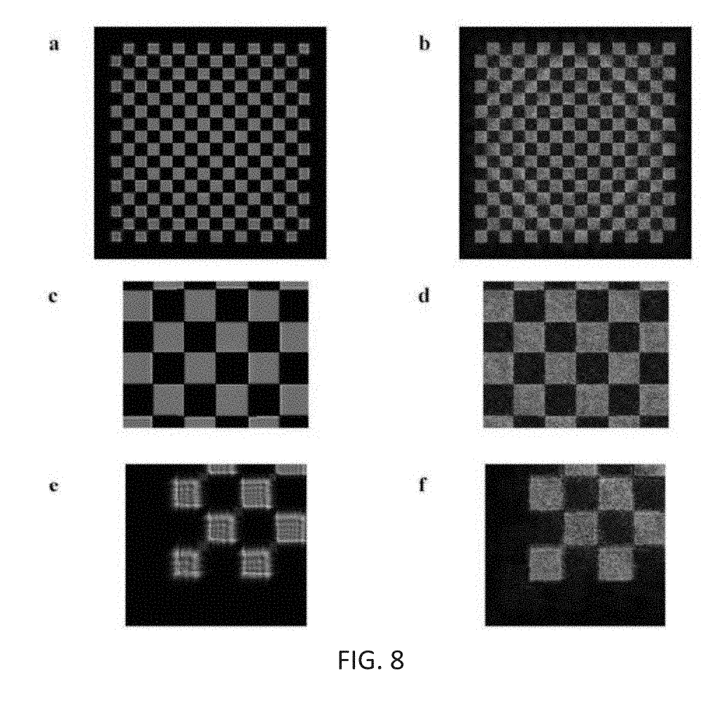

FIG. 8 illustrates how the system is capable of forming images of complete objects as well, using as an example a black and white checkerboard pattern. Panels a and b of FIG. 8 illustrate the pattern imaged with the regular diffractive and holographic systems, respectively. Panels c-f show zoomed-in views of the center and a corner of the images. In particular, panel a is an image of a 16×16 black and white checkerboard pattern using standard single diffractive lens imaging. Panel b is an image of the same checkerboard pattern of panel a, using the single lens holographic technique of the present disclosure. Off axis aberrations are evidently much more pronounced in the standard imaging technique of panel a. Panels c-f are zoomed-in images of the checkerboard pattern to better show the discrepancies off axis. The center of the pattern imaged with a standard diffractive lens is shown in panel c, while panel d shows the same center pattern imaged with the holographic method. A corner of the pattern imaged with a standard diffractive lens is shown in panel e, while panel f shows the same corner pattern imaged with the holographic method. The noise in the holographic images (panels b, d and f) is due to software approximations when creating the holograms on the CCD, and is not due to the reconstruction algorithm. The software approximations would not be needed in actual imaging, therefore the quality of the images would be higher than the example shown in FIG. 8. FIG. 8 is meant to illustrate how the holographic technique can image equally well both the center and corners of the image, while the standard technique presents significant aberrations at the corners.

While both systems form a good quality image at the center (panels c-d), at the corner (panels e-f) the regular diffractive lens image (panel e) is significantly blurred. By contrast, the holographic system forms a sharp image with low aberrations in the corners as well. The high frequency noise seen in the reconstructed holographic image is a result of the forward hologram formation method. Since different points on the object should be incoherent light sources, to form the hologram random phases were assigned to each point on the object, and averaged over a large number of images with different phases. Since the noise dies off at a 1/\sqrt{M} rate (M being the number of images with different phases averaged), it is not negligible even for relatively large averages. It should be noted, however, that since the hologram formation is done automatically in the measurements, this type of noise will not be present in actual measurements.

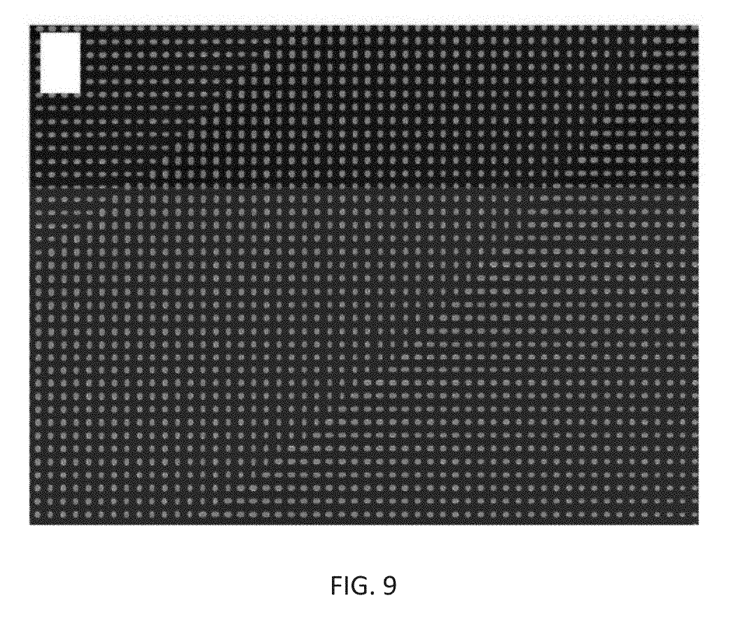

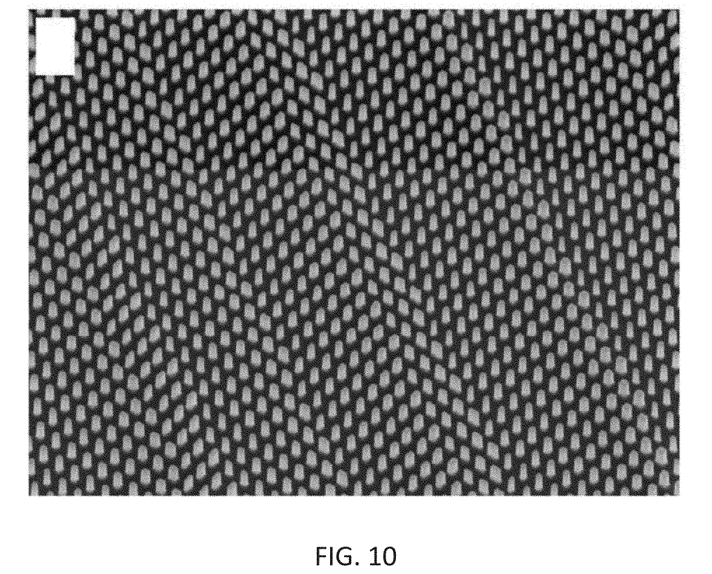

FIG. 9 illustrates a scanning electron microscope (SEM) image of a fabricated birefringent dielectric metasurface lens, viewed from above. FIG. 10 illustrates the same metasurface lens, viewed from a tilted angle. The metasurface comprises an array of nanoscatterers, in this case rectangular nanoposts of different orientation and size. The rectangular shape allows polarization effects due to its asymmetry. The lens is composed of rectangular silicon nanoposts that impart different phase profiles, resulting in different phase focal distances for the two linear polarizations.

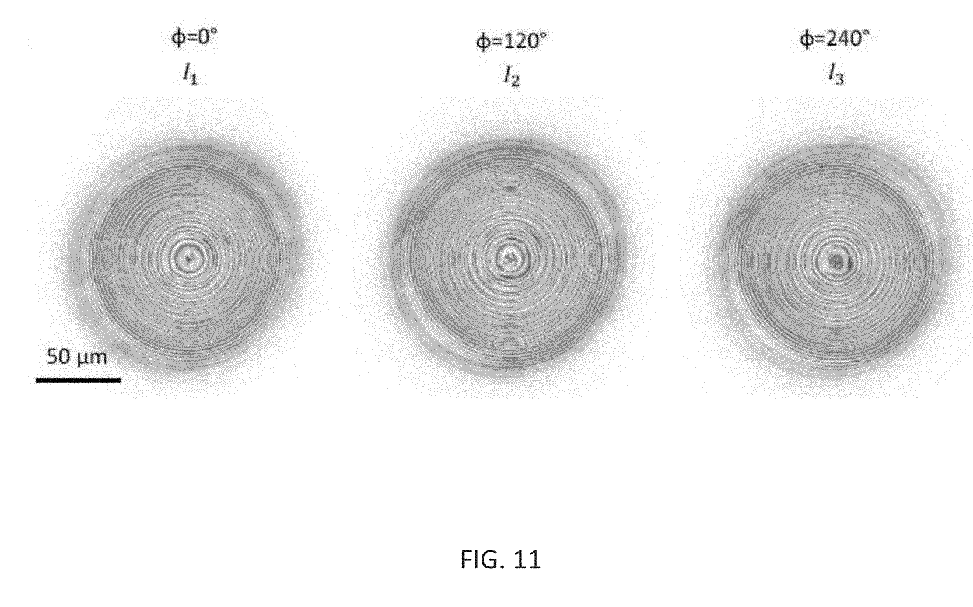

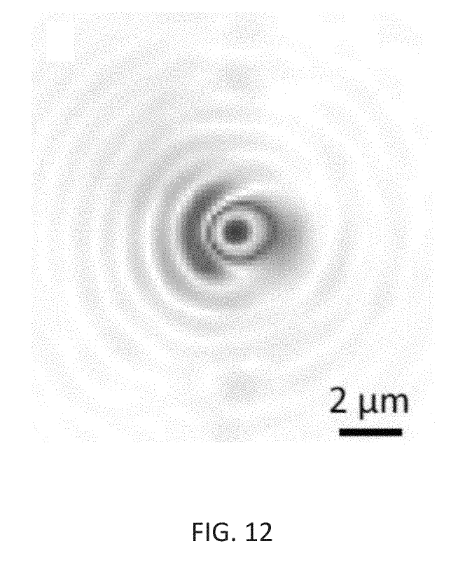

Three interference patterns of a point source formed by the fabricated birefringent lens for three different phases are shown in FIG. 11, while FIG. 12 shows the reconstructed focus pattern. In particular, FIG. 11 illustrates measured interference patterns for three different phases of the wave plate when a fiber tip (effectively a point source) is used as an illumination source. The resulting intensities are denoted as I₁, I₂, and I₃ for the three phases of 0°, 120°, and 240°, respectively. A scale bar of 50 micrometers is illustrated. FIG. 12 illustrates the reconstructed focus from the resulting hologram, with a 2 micrometer scale bar.

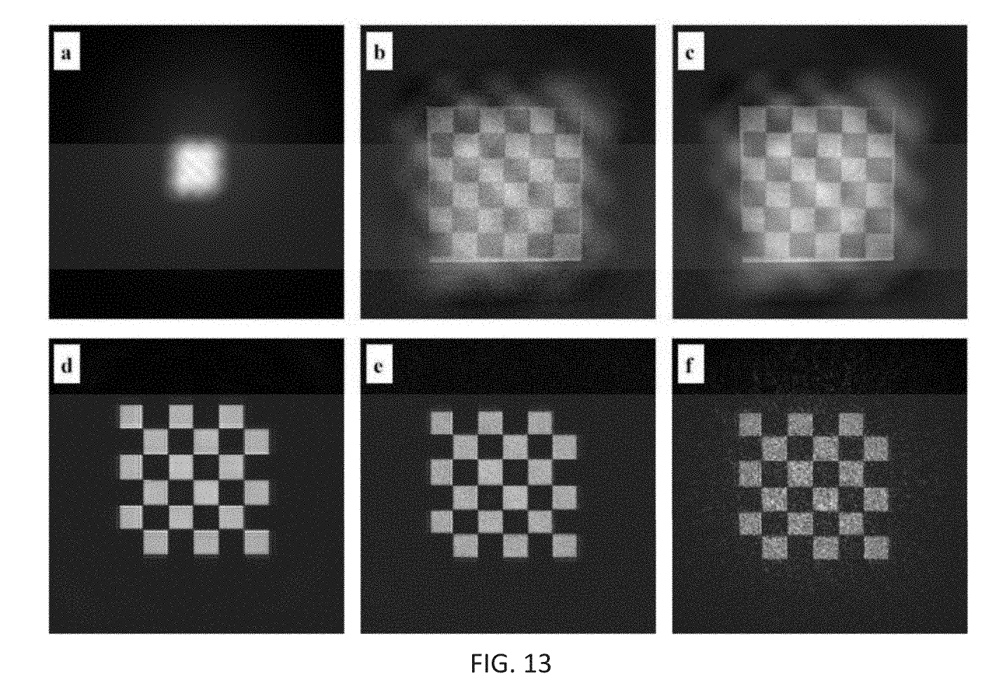

FIG. 13 illustrates the experimentally captured interference patterns in panels a-c, and the reconstructed images using the holographic method of the present disclosure in panels d-f. For comparison, panels d-f show the simulated reconstructed images without noise in panel d, with added uncorrelated noise in panel e, and with added correlated noise in panel f. In particular, panel a illustrates the measured interference pattern, I₁, for a checkerboard pattern placed in front of the imaging system. Panel b illustrates the reconstructed image from the hologram formed of the three measured interference patterns. Panel c illustrates the reconstructed image when each interference pattern is averaged over five captures to reduce the random noise. Panel d illustrates the simulated reconstructed image of the same checkerboard pattern. Panel e illustrates the simulated reconstructed image with added noise to the interference patterns. The signal to noise ratio (SNR) was set to 10, and the noise has no correlation to the signal. Panel f illustrates the simulated reconstructed image when the added noise power (SNR=100) is proportional to the signal.

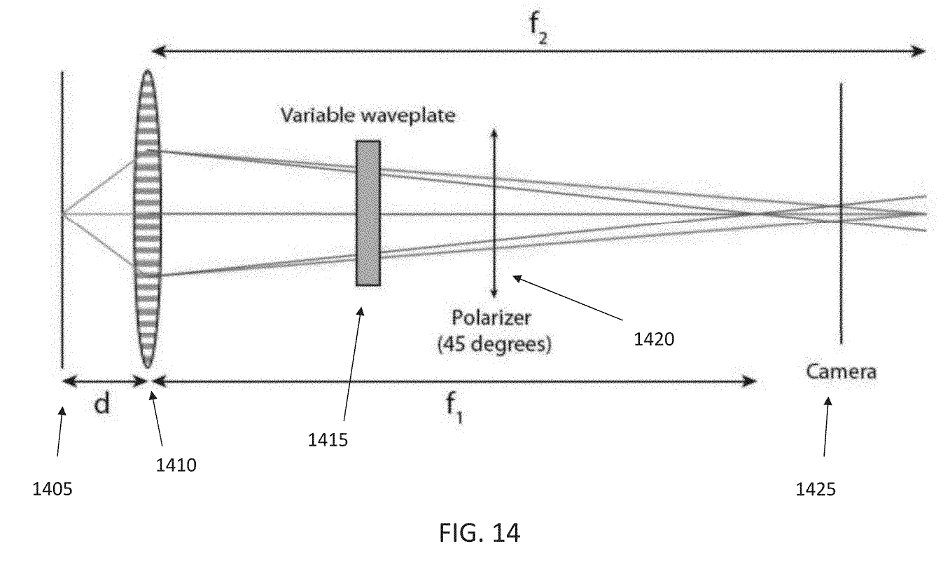

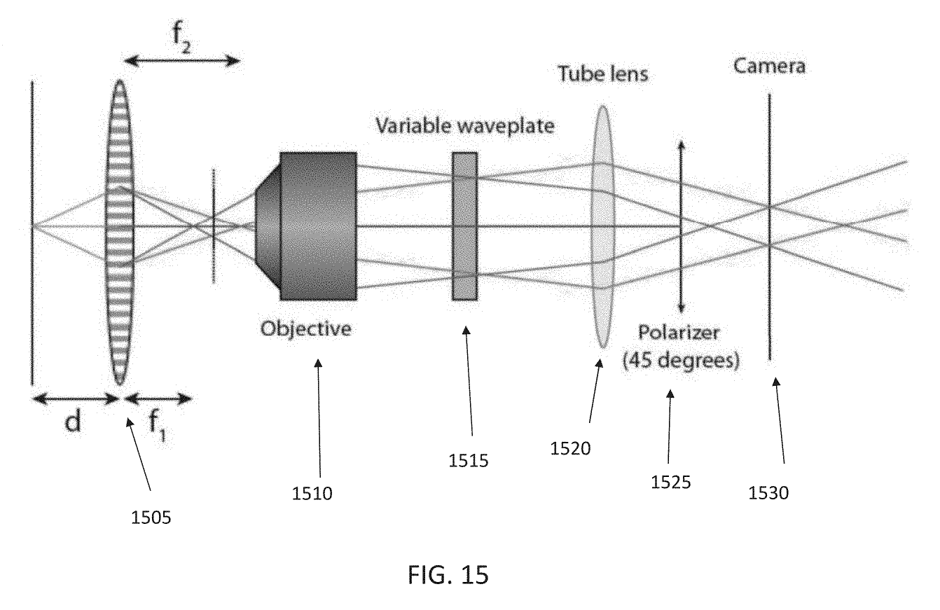

The structure and methods described in the present disclosure can be utilized in other configurations as well. For instance, if the lens is corrected to image a plane of finite distance (i.e. working distance) to two different planes for the different polarizations, the structure can be used in the configurations shown in FIGS. 14-15 as a microscope. The fundamentals of operation for these devices will be the same as described above.

FIG. 14 illustrates a schematic of the holographic imaging method of the present disclosure, used in a microscopy configuration. In this configuration, d<<f₁, f₂, resulting in a large magnification. FIG. 15 illustrates a schematic of the holographic imaging method in a different microscopy configuration. In this configuration the magnification comes from the regular microscope, and d and f₁, f₂ can be of the same order of magnitude. FIG. 14 illustrates an object plane (1405), a metasurface lens (1410), a variable wave plate (1415), a polarizer (1420), and a camera plane (1425). FIG. 15 illustrates a metasurface lens (1505), an objective (1510), a variable wave plate (1515), a tube lens (1520), a polarizer (1525), and a camera plane (1430).

The structure and methods of the present disclosure are not limited to using a diffractive lens with two different focal distances for two polarizations. The concept can be generalized to using other diffractive metasurface devices, with different phase profiles for the two polarizations. In general, the metasurfaces of the present disclosure can implement any two phase profiles for the two incident polarizations, as long as the corresponding field distributions on the image sensor are approximately complex conjugates of each other, i.e., u₁≈u*₂. This condition ensures that the interference intensities I₁, I₂, and I₃ (as defined above in the present disclosure) are non-dispersive and do not change significantly with the wavelength. This condition in turn ensures the wideband operation of the technique and of the device, and allows overcoming the limitations caused by chromatic dispersion.

In some embodiments, the nanoposts of the present disclosure are asymmetric, for example having rectangular or elliptical cross section, and have lateral dimensions and a height of less than one micrometer. In some embodiments, the first focal length is shorter than a distance between the birefringent metasurface lens and the camera, and the second focal length is longer than a distance between the birefringent metasurface lens and the camera.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The references in the present application, shown in the reference list below, are incorporated herein by reference in their entirety.

### REFERENCES

[1] Kamali, S. M.; Arbabi, E.; Arbabi, A.; Faraon, A., “A review of dielectric optical metasurfaces for wavefront control,” Nanophotonics 7, pp. 1041-1068, 2018.
[2] Arbabi, A., Horie, Y., Ball, A. J., Bagheri, M., and Faraon, A., “Subwavelength-thick lenses with high numerical apertures and large efficiency based on high-contrast transmitarrays,” Nature communications 6 (7069), 2015.
[3] Arbabi, A., Arbabi, E., Kamali, S. M., Horie, Y., Han, S., and Faraon, A., “An optical metasurface planar camera,” arXiv preprint arXiv: 1604.06160, 2016.
[4] Arbabi, A., Horie, Y., Bagheri, M., and Faraon, A., “Dielectric metasurfaces for complete control of phase and polarization with subwavelength spatial resolution and high transmission,” Nature Nanotechnology 10, pp. 937-943, 2015. [5] Arbabi, E., Arbabi, A., Kamali, S. M., Horie, Y., and Faraon, A. “Multiwavelength polarization-insensitive lenses based on dielectric metasurfaces with meta-molecules,” Optica 3(6), pp. 628-633, 2016.
[6] Rosen, J., Siegel, N., and Brooker, G., “Theoretical and experimental demonstration of resolution beyond the Rayleigh limit by FINCH fluorescence microscopic imaging,” Optics express 19(27), pp. 26249-26268, 2011.
[7] Siegel, N., Rosen, J., and Brooker, G., “Reconstruction of objects above and below the objective focal plane with dimensional fidelity by FINCH fluorescence microscopy,” Optics express 20(18), pp. 19822-19835, 2012.

What is claimed is:

1. A device comprising:
a birefringent metasurface lens, comprising an array of nanoposts configured to focus incident electromagnetic waves of a first polarization to a first focal length, and incident electromagnetic waves of a second polarization to a second focal length;
a variable phase retarder between the birefringent metasurface lens and a camera, the variable phase retarder configured to vary a phase difference between the electromagnetic waves of the first polarization and the electromagnetic waves of the second polarization; and
a polarizer between the variable phase retarder and the camera.

2. The structure of claim 1, wherein the variable phase retarder is a variable wave plate.

3. The structure of claim 1, wherein the first polarization is orthogonal to the second polarization, and the polarizer is configured to polarize at 45° from the first polarization.

4. The structure of claim 1, wherein the nanoposts of the array of nanoposts have an asymmetric cross section.

5. The structure of claim 4, wherein the asymmetric cross section is rectangular or elliptical.

6. The structure of claim 1, wherein the first focal length is 1.25 mm and the second focal length is 1.75 mm.

7. The structure of claim 1, wherein the first focal length is shorter than a distance between the birefringent metasurface lens and the camera, and the second focal length is longer than a distance between the birefringent metasurface lens and the camera.

8. A method comprising:
providing a birefringent metasurface lens comprising an array of nanoposts;
providing a variable phase retarder between the birefringent metasurface lens and a camera;
providing a polarizer between the variable phase retarder and the camera;
focusing electromagnetic waves of a first polarization, from an object to be imaged and incident on the birefringent metasurface lens, to a first focal length, and electromagnetic waves of a second polarization, from the object and incident on the birefringent metasurface lens, to a second focal length;
varying, by the variable phase retarder, a phase difference between the electromagnetic waves of the first polarization and the electromagnetic waves of the second polarization;
capturing, by the camera, a plurality of interference patterns for a plurality of phase differences between the electromagnetic waves of the first polarization and the electromagnetic waves of the second polarization, wherein each interference pattern of the plurality of interference patterns corresponds to a phase difference of the plurality of phase differences; and
generating a hologram from the plurality of interference patterns.

9. The method of claim 8, wherein the plurality of interference patterns comprises at least three interference patterns corresponding to three phase differences of the plurality of phase differences.

10. The method of claim 9, wherein the three phase differences are 0°, 120°, and 240°.

11. The method of claim 8, further comprising reconstructing an image of the object from the hologram.

12. The method of claim 8, wherein the variable phase retarder is a variable wave plate.

13. The method of claim 8, wherein the first polarization is orthogonal to the second polarization, and the polarizer is configured to polarize at 45° from the first polarization.

14. The method of claim 8, wherein the nanoposts of the array of nanoposts have an asymmetric cross section.

15. The method of claim 14, wherein the asymmetric cross section is rectangular or elliptical.

16. The method of claim 8, wherein the first focal length is 1.25 mm and the second focal length is 1.75 mm.

17. The method of claim 8, wherein the first focal length is shorter than a distance between the birefringent metasurface lens and the camera, and the second focal length is longer than a distance between the birefringent metasurface lens and the camera.

18. The method of claim 8, wherein the generating the hologram comprises generating a linear combination of the interference patterns.

19. A device comprising:
a birefringent metasurface, comprising an array of nanoposts configured to scatter incident electromagnetic waves of a first polarization with a first phase profile, and incident electromagnetic waves of a second polarization with a second phase profile;
a variable phase retarder between the birefringent metasurface and a camera, the variable phase retarder configured to vary a phase difference between the electromagnetic waves of the first polarization and the electromagnetic waves of the second polarization; and
a polarizer between the variable phase retarder and the camera.
